(19) United States
(12) Patent Application Publication
(10) Pub. No.: US 2019/0018600 A1
(43) Pub. Date: Jan. 17, 2019

(54) RESTRUCTURED INPUT/OUTPUT REQUESTS

(71) Applicant: HEWLETT PACKARD ENTERPRISE DEVELOPMENT LP, Houston, TX (US)

(72) Inventors: Richard J. TOMASZEWSKI, Houston, TX (US); Jeff W. WOLFORD, Spring, TX (US)

(73) Assignee: Hewlett Packard Enterprise Development LP, Houston, TX (US)

(21) Appl. No.: 16/068,645

(22) PCT Filed: Jan. 13, 2016
(86) PCT No.: PCT/US2016/013270

§ 371 Date: Jul. 6, 2018

(51) Int. Cl. G06F 3/06; G06F 13/10; G06F 1/28

(52) U.S. Cl. CPC G06F 3/0613; G06F 13/102; G06F 1/28; G06F 3/0673; G06F 3/0656; G06F 3/0659

(57) ABSTRACT

Example implementations relate to a restructuring input/output requests directed to a storage device. For example. In an implementation, a storage controller may receive input/output requests directed to a storage device, monitor a power variable of the storage device, restructure the received I/O requests based on properties information about the storage device and a workload level of the received I/O requests, and submit the restructured I/O requests to the storage device. The restructured I/O requests, when serviced by the storage device, allow the power variable to conform with a power policy.

### BACKGROUND

Components of computing systems and storage systems may generate heat. Excessive heat may impact the reliability and performance of computing and storage systems. The amount of heat generated by a component may correspond to the workload of the component.

### BRIEF DESCRIPTION OF THE DRAWINGS

Various examples will be described below with reference to the following figures.

FIG. 1 is a block diagram of an example apparatus that includes a machine readable medium encoded with instructions to restructure input/output requests directed to a storage device.

FIG. 2 is a block diagram of an example apparatus that includes a machine readable medium encoded with instructions to cache, buffer, reorder, merge, or modulate input/output requests directed to a storage device.

FIG. 3 is a block diagram of an example apparatus that includes a machine readable medium encoded with instructions for distribution of input/output requests among other storage devices.

FIG. 4 is a block diagram of an example storage controller that includes a machine readable medium encoded with instructions to restructure input/output requests directed to a storage device.

FIG. 5 is a block diagram of an example storage controller that includes a machine readable medium encoded with instructions to modulate, reorganize, or redistribute input/output requests.

FIG. 6 is a block diagram of an example computing environment that may employ a storage manager according to an implementation.

FIG. 7 is a flowchart of an example method for restructuring input/output requests directed to a storage device.

FIG. 8 is a flowchart of an example method for modeling a predicted impact of received input/output requests and restructuring the input/output requests based on the predicted impact.

### DETAILED DESCRIPTION

The performance and reliability of computing systems or storage systems may be sensitive to internal temperatures of the systems, and more particularly, the temperatures of components within the systems. For example, heat may be generated by electrical resistance when processors are executing instructions and when memory or storage media (e.g., solid state drives) are reading and writing data. Heat also may be generated from mechanical parts, such as, motors for spinning storage media including hard disk drive platters or optical disks, arms for moving a read head to read spinning media, and friction associated with mechanical parts. Heat also may be generated from other sources, such as light sources (e.g., lasers) used in optical media and other photonics devices.

The amount of heat generated by a component may correspond with the workload of the component. For example, a storage device may generate heat when servicing input/output (I/O) requests, that is when performing data reads and data writes on storage media. The amount of heat generated by a storage device may correspond to characteristics of I/O requests serviced by the storage device, such as a quantity, rate, complexity, etc. of the I/O requests.

Keeping the temperature of system components, and the system in general, within operating temperature limits may help to minimize system failures and performance problems. Some techniques for managing system and component temperatures include fans, heat sinks, and liquid cooling. Such techniques rely on heat exchange, but increases in ambient temperature, a fan failure, or a blocked exhaust could weaken or nullify the effectiveness of heat exchange, and lead to system thermal shutdown, system failure, or even permanent system damage.

To mitigate risk stemming from ineffective heat exchange, some components themselves may employ workload throttling triggered by a temperature limit to reduce component power consumption and heat generation. However, implementation of temperature-triggered workload throttling on components may vary between manufacturers, which may result in unpredictable system performance and reliability.

Example techniques of the present application may relate to, among other things, an apparatus that receives input/output (I/O) requests directed to a storage device, monitors a power variable (e.g., a temperature) of the storage device, retrieve storage device properties information, restructure the received I/O requests based on at least the retrieved storage device properties information and a workload level of the received I/O requests, and submit the restructured I/O requests to the storage device. The restructured I/O requests, when serviced by the storage device, allow the power variable of the storage device to conform with a power policy. For example, the power policy may be a target temperature, a temperature goal (e.g., lowest achievable temperature), or the like. Accordingly, the systems end techniques of the present description may be useful for reducing activity of a storage device to manage thermal power generation or electrical power consumption of the storage device.

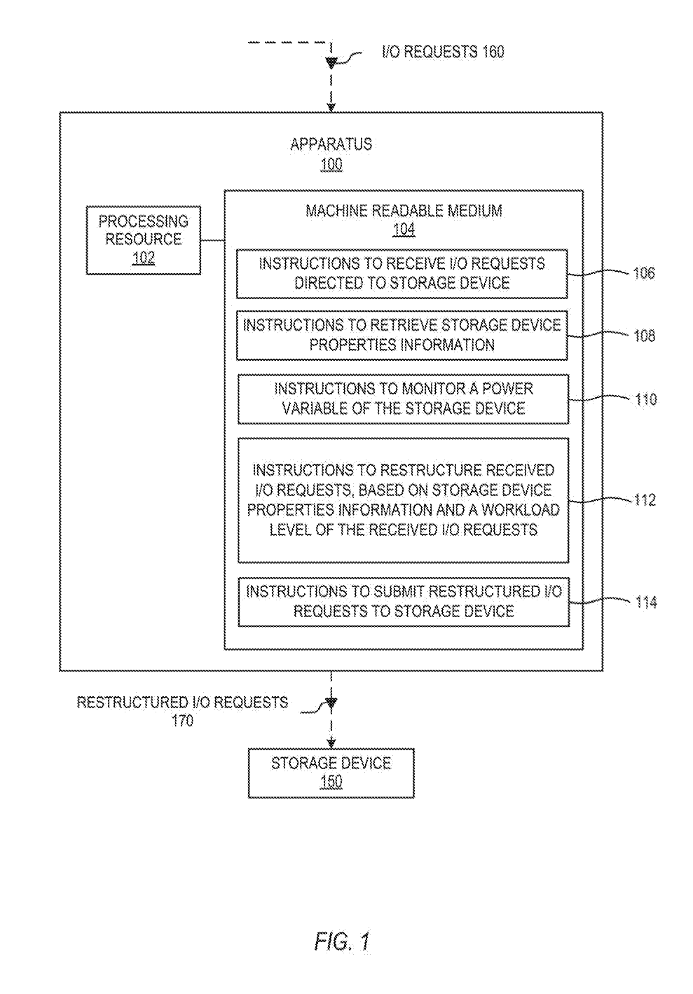

Referring now to the figures, FIG. 1 is a block diagram of an example apparatus 100 that includes a processing resource 102 coupled to a non-transitory machine readable medium 104 storing (or encoded with) instructions 106, 108, 110, 112, 114. The term “non-transitory” does not encompass transitory propagating signals. The apparatus 100 may be employed in a system, such as a computing system (e.g., a server, a workstation, a desktop computer, a laptop computer, a portable device, etc.) or a storage system (which may be employed in a data center, for example).

In some implementations, the processing resource 102 may be a microcontroller, a microprocessor, central processing unit core(s), an application-specific integrated circuit (ASIC), a field programmable gate array (FPGA), and/or other hardware device suitable for retrieval and/or execution of instructions 106-114 stored on the machine readable medium 104. The machine readable medium 104 may be random access memory (RAM), read-only memory (ROM), electrically erasable programmable read-only memory (EEPROM), flash memory, a hard disk drive, etc. The instructions 106-114, when executed, cause the processing resource 102 to perform the functionality described herein. Additionally or alternatively, the processing resource 102 may include one or more hardware devices, including electronic circuitry, for implementing functionality described herein.

In some implementations, the apparatus 100 may be connected directly to a storage device 150 (e.g., via an internal or external data bus), or the apparatus 100 may communicate with the storage device 150 over a wired or wireless network (e.g., Wi-Fi, Ethernet, Fibre Channel, etc.). The storage device 150 may be, for example, a hard disk drive (HDD), a solid state drive (SSD), a non-volatile memory (NVM), a flash drive, a magnetic tape drive or tape library (with magnetic tape), an optical disc drive or jukebox (with optical media, e.g., CD, DVD, etc.), a storage array, or the like. The storage device 150 may be installed in a system (e.g., computing system or storage system) that is the same or different as the system in which the apparatus is installed.

Instructions 106 cause the processing resource 102 to receive input/output (I/O) requests 160 directed to a storage device 150. I/O requests 160 relate to reading data from or writing data to the storage device 150. In some examples, the apparatus 100 receives the I/O requests 160 from a processor installed in a same system as the apparatus 100 (e.g., both the processor and the apparatus 100 being installed in a same server). In other examples, the apparatus 100 receives the I/O requests 160 from a system over a wired or wireless network. In some implementations, instructions 106 may quantify the received I/O requests 160 into an I/O workload level, which may be a measure having units of, for example, number of requests per second or bytes per second.

Instructions 108 cause the processing resource 102 to retrieve storage device properties information. For example, the processing resource 102 may retrieved the storage device properties information from the storage device 150 directly, from UEFI (unified extensible firmware interface) or BIOS (basic input/output system) of the system in which the storage device is installed, or from other like sources. Storage device properties information may be specific to the storage device 150, may be specific to the model of the storage device 150, or may relate more generally to a class of storage devices (e.g., HDD, SSD, etc.). Examples of storage device properties information include a media type of the storage device, an electrical power consumption rate for a workload level, or a thermal power generation rate for a workload level. The storage device properties information may also include operating limits, such as electrical or thermal operating limits.

Media type information may specify whether the storage device 150 is of a certain category, such as, for example, spinning media, non-spinning media, solid state media, optical media, magnetic media, tape media, non-volatile memory, etc. The media type information may specify details of the foregoing categories, such as rotational speed if the storage device 150 is spinning media, an indication (explicit or implicit) of the number of channels of an SSD, a technology type of non-volatile memory (e.g., memristor, spin-transfer torque, phase change memory, etc.), or the like.

Electrical power consumption rate for a workload level may be a characteristic of the storage device 150 specified in units of, for example, electrical watts per I/O request per second. Similarly, a thermal power generation rate for a workload level may be a characteristic of the storage device 150 specified in units of, for example, thermal watts per I/O request per second. In other words, it may be known by design or testing how much electrical power is consumed or how much thermal power is generated when the storage device 150 processes various workload levels.

Instructions 110 cause the processing resource 102 to monitor a power variable of the storage device. A power variable is a quantity that implicitly or explicitly represents thermal activity (e.g., temperature, heat flux, etc.) related to the storage device. In some implementations, instructions 108 can monitor multiple power variables.

In an example, a power variable may be a speed of a fan, such as a fan of a chassis or housing that encloses the storage device 150 or a fan coupled to the storage device 150. The fan speed may relate to the thermal activity of the storage device 150, particularly when the fan is controlled by a temperature-based fan controller that uses temperature of the storage device 150 as an input.

In another example, the power variable may be a measurement of thermal power generated at the storage device 150. For example, the power variable may be a signal from a temperature sensor (e.g., a thermocouple) or a heat flux sensor on or near the storage device 150. The thermal power measurement may explicitly relate to thermal activity of the storage device 150.

In another example, the power variable may be a measurement of electrical power consumed by the storage device 150. For example, the electrical power measurement may be a voltage and/or current measurement of a power supply rail or of a power input info the -storage device 150. An electrical power measurement may correlate to thermal activity of the storage device 150, because the storage device 150 may convert some electrical power into heat as a byproduct, for example. For a particular electrical power measurement, different storage devices may generate different amounts of heat.

In another example, the power variable may be an estimate of thermal power generated by the storage device 150, as calculated by the processing resource 102 based on monitored workload levels and storage device properties information. For example, the processing resource 102 may calculate the estimated thermal power generated by multiplying the “thermal power generation rate for a workload level” storage device properties information, as may be retrieved by instructions 108 described above, and a workload level for I/O requests that have been previously submitted to the storage device 150. Estimated thermal power generation may explicitly relate to thermal activity of the storage device 150 from processing those submitted I/O requests.

In another example, the power variable may be an estimate of electrical power consumed by the storage device 150, as calculated by the processing resource 102 based on monitored workload levels and storage device properties information. For example, the processing resource 102 may calculate the estimated electrical power consumed by multiplying the “electrical power consumption rate for a workload level” storage device properties information, as may be retrieved by instructions 108 described above, and the workload level of I/O requests that have been previously submitted to the storage device 150. Estimated electrical power consumption may correlate to thermal activity of the storage device 150, because the storage device 150 may convert some electrical power into heat as a byproduct when processing those submitted I/O requests.

Instructions 112 cause the processing resource 102 to restructure the received I/O requests 160 (i.e., received by instructions 106), based on the retrieved storage device properties information (i.e., retrieved by instructions 108) and a workload level of the received I/O requests 160 (i.e., quantified by instructions 106). Instructions 112 restructure the I/O requests 160 so that when the restructured I/O requests 170 are serviced by the storage device 150, the restructured I/O requests 170 allow or cause the power variable to conform with a power policy.

For example, the power policy may be a target value (or a threshold), such as a temperature target, an electrical power consumption target, a thermal power generation target, or the like. The power policy may be an operating limit of the storage device 150 retrieved by instructions 108 as storage device properties information. The power policy may be to reduce spiking in the power variable.

In another implementation, the power policy may be a goal of achieving the lowest possible value for the power variable. In some implementations, the power policy may be a goal of balancing the power variable and I/O performance (e.g., servicing greater than or equal to a predefined threshold rate of I/O requests per unit time). In some cases, a priority of the received I/O request 160 (e.g., a high priority, system/application criticality, etc.) may dictate to what extent the I/O requests 160 can be restructured. For example, high priority I/O requests may be excluded from restructuring under a power-performance balancing power policy.

In some implementations, instructions 112 may restructure received I/O requests 160 by open-loop control (e.g., I/O requests are restructured without factoring the power variable into the control). In some implementations, the power policy may be employed in a closed-loop feedback control to manage the monitored power variable. In some implementations, instructions 112 may restructure the I/O requests 160 when the monitored power variable (monitored by instructions 110) approaches or exhibits non-compliance with the power policy. For example, if a measured temperature of the storage device 150 (i.e., the power variable) exceeds a predefined temperature threshold (i.e., the power policy), instructions 112 may be triggered to restructure the I/O requests 160.

In some implementations, instructions 112 may model a predictive impact of the received I/O requests 160 on the power variable. For example, instructions 112 may estimate an incremental change in the power variable (e.g., electrical power that would be consumed or the thermal power that would be generated) if the storage device 150 serviced the I/O requests 160 as received, by multiplying the workload level of the received I/O requests 160 and “thermal power generation rate for a workload level” storage device properties information (or alternatively, the “electrical power consumption rate for a workload level” storage device properties information). In some implementations, instructions 112 may add that incremental change to a present measurement or estimate of the power variable to determine a projected gross value for the power variable.

Instructions 112 may formulate a proposed restructuring of the I/O requests 160 (Which may employ techniques described herein below, e.g., such as instructions 206, 208, 210,212, 314, or combinations thereof) and generate an estimated incremental change and/or projected gross value of the power variable upon servicing the proposed restructured I/O requests. The proposed restructuring may depend on the nature of the I/O requests and the storage device properties information. For example, if the storage device 150 is categorized as spinning media, instructions 112 may restructure the I/O requests 160 to reduce additional seeking or spinning of the storage device 150 (and thus reduce electrical power consumption or thermal power generation), particularly if the storage device 150 is not presently spinning. In some implementations, instructions 112 may test multiple proposals for restructuring the I/O requests 160.

If servicing the restructured I/O requests is projected to conform more closely to the power policy than servicing the I/O requests 160 as received, the processing resource 102 can execute instructions 114 to submit the restructured I/O requests 170 to the storage device 150 (e.g., over a data bus). In some implementations, the processing resource 102 may continue to monitor the power variable to determine whether the restructured I/O requests 170 actually perform as predicted and/or to use the power variable as a closed-loop feedback control input variable.

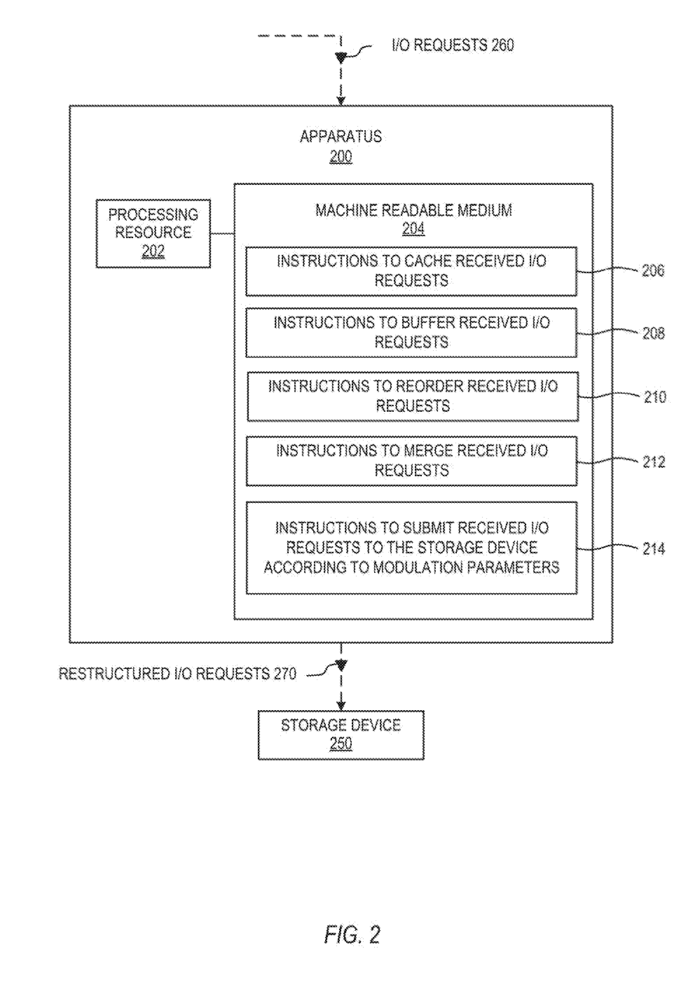

FIG. 2 is a block diagram of an example apparatus 200 that includes a machine readable medium encoded with instructions to restructure received I/O requests according to various techniques. The apparatus 200 includes a processing resource 202 and a non-transitory machine readable medium 204, which may be analogous in many respects to the processing resource 102 and the non-transitory machine readable medium 104, respectively. The machine readable medium 204 may store instructions 206, 208, 210, 212, 214.

The apparatus 200 may receive I/O requests 260 (which may be analogous in many respects to the I/O requests 160) directed to a storage device 250 (which may be analogous in many respects to the storage device 150), may restructure the received I/O requests 260 according to the instructions described herein to allow a power variable of the storage device 250 to conform with a power policy, and submit the restructured I/O requests 270 to the storage device 250. That is, the restructured I/O requests 270 are the received I/O requests 260 after being restructured by caching (206), buffering (208), reordering (210), merging (212), and/or modulation (214), as will be described below.

In some implementations, the instructions of apparatus 200 may be utilized by instruction 112 of apparatus 100 to restructure I/O requests. In other words, instructions 112 may utilize the instructions of apparatus 200 to conform a monitored power variable of a storage device to a power policy.

Instructions 206 cause the processing resource 202 to restructure received I/O requests 260 by caching at least some of the received I/O requests 260 (or more particularly, caching data associated with the I/O requests 260). Servicing the I/O requests out of a cache may reduce the electrical power consumption or thermal power generation of the storage device 250 by, for example, offloading I/O from the storage device 250 and reducing utilization of the storage device 250. Caching may be performed according to a least recently used (LRU) technique, or the like. In some implementations, at least some of the data associated with the I/O requests 260 may be cached in memory (e.g., RAM).

In some implementations, instructions 206 may cache the received I/O requests 260 (or data associated with the I/O requests 260) in a different tier of tiered storage, in cases where the storage device 250 may be or may form part of tiered storage. Tiered storage may be designed around performance (e.g., access speed), offering graduated levels of performance from a fast access tier (e.g., SSD) to a slower archival tier in some examples, but some tiers also may have power characteristics (electrical consumption or thermal generation) that differ from other tiers. Accordingly, instructions 206 may leverage different power characteristics of tiers to manage the power variable by, for example, caching I/O requests or data to a lower power usage or generating tier.

Instructions 208 cause the processing resource 202 to restructure received I/O requests 260 by buffering at least some of the received I/O requests 260, in a queue for example. In other words, the apparatus 100 may temporarily delay submission of the I/O requests 260 to the storage device 250 for servicing. By time-delaying submission of the I/O requests, the storage device 250 may have time to cool and to reduce the power variable. In some implementations, an I/O request 260 may be buffered if the storage device 250 is not presently active (e.g., an HDD not presently spinning), and submitted together with a later received I/O request directed to the same storage device 250 to improve overall efficiency of the storage device 250. Buffering by instructions 208 may be used in conjunction with other techniques described herein for restructuring I/O requests.

Instructions 210 cause the processing resource 202 to restructure received I/O requests 260 by reordering at least some of the received I/O requests 260. In some implementations, instructions 210 may analyze buffered I/O requests (a plurality of received I/O requests stored in a buffer according to instructions 208), and reorder the I/O requests in a progression that reduces the amount of storage device activity involved in servicing the I/O requests based on storage device properties information. For example, I/O requests 260 in the order as received may be addressed to address locations scattered across the platters of an HDD storage device 250, and instructions 210 may reorder the I/O requests 260 to reduce seeks (and thus reduce platter spinning and seek arm motion). Similarly, for an SSD storage device 250, instructions 210 may reorder the I/O requests 260 to reduce the number of channels utilized to service the I/O requests.

Instructions 212 cause the processing resource 202 to restructure received I/O requests 260 by merging at least some of the received I/O requests 260. For example, instructions 212 may analyze buffered I/O requests (buffered according to instructions 208), and group certain I/O requests to be serviced together to reduce the impact on the power variable of the storage device 250. For example, instructions 210 may group I/O requests addressed to adjacent or nearby address locations on the storage device 250. Accordingly, two I/O requests may become one I/O request, which may reduce activity of the storage device 250. For example, an HDD storage device may seek less and an SSD storage device may utilize fewer channels to service restructured I/O requests 270 merged in this manner.

In a power policy which aims to balance power and performance, the apparatus 200 may forego merging I/O requests via instructions 212 for other I/O request restructuring techniques, because merging may delay submission of an I/O request to the storage device until that I/O request can be merged with another I/O request, and such delay may be antithetical to performance demands.

Instructions 214 cause the processing resource 202 to restructure the received I/O requests 260 by modulated submission of the received I/O requests 260 to the storage device 250. The submission of the received I/O requests 260 may be modulated according to modulation parameters that include an I/O request submission rate (e.g., a number of requests submitted per second), an I/O request submission duty cycle, or a number of available I/O lanes (e.g., for a SSD storage device).

Modulation of the received I/O requests 260 may be accomplished by despooling I/O requests that have been buffered (by instructions 208), as restructured I/O requests 270. In some implementations, instructions 214 may burst out some buffered I/O requests from a buffer at intervals in conformance with the modulation parameters, and/or when the buffer is full or close to full (e.g., at a predefined level of buffer fill). The storage device 250 may be more likely to maintain its power variable in compliance with the power policy when servicing modulated I/O requests than when servicing I/O requests continuously for an extended period of time. In some implementations, I/O requests may be modulated to reduce the number of active I/O lanes active at any given time (e.g., by modulating requests to I/O lanes out of phase).

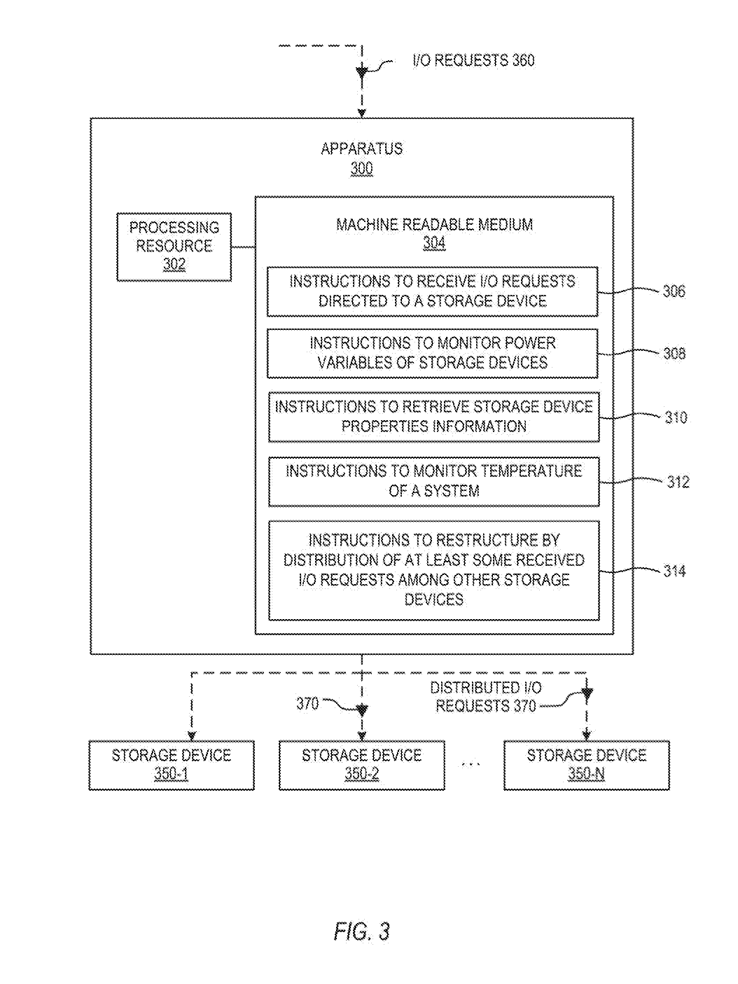

FIG. 3 is a block diagram of an example apparatus 300 that includes a machine readable medium encoded with instructions to restructure received I/O requests by distribution of I/O requests among other storage devices. The apparatus 300 includes a processing resource 302 and a non-transitory machine readable medium 304, which may be analogous in many respects to the processing resource 102 and the non-transitory machine readable medium 104, respectively. The machine readable medium 304 may store instructions 306, 308, 310, 312, 314.

The apparatus 300 can communicate with a plurality of storage devices 350-1 through 350-N (collectively or generally 350) by way of a data bus or a network (wired or wireless). The storage devices 350 may be analogous in many respects to the storage device 150. Some of the storage devices 350 may be in a same enclosure or system as the apparatus 300, and I/O requests to those storage devices may run through the apparatus 300.

Instructions 306 cause the processing resource 302 to receive I/O requests 360 directed to a storage device. The examples that follow may discuss I/O requests 360 directed to storage device 350-1, but it should be understood that the processing resource 302 may receive I/O requests directed to any of the storage devices 350. Instructions 306 may be analogous in many respects to instructions 106.

Instructions 306 cause the processing resource 302 to monitor the power variables of the storage devices 350 (including the storage device 350-1 to which the I/O requests 360 are directed and at least some of the other storage devices 350-2 through 350-N). Instructions 308 may monitor same or different power variables for the storage devices 350, and the power variables may be analogous to those described above with respect to instructions 110.

Instructions 310 cause the processing resource 302 to retrieve storage device properties information for at least some of the storage devices 350 (including the storage device 350-1). The storage device properties information may be analogous to the storage device properties information described above with respect to instructions 108.

Instructions 312 cause the processing resource 302 to monitor a temperature of a system, such as the computing or storage system(s) in which the storage devices 350 are installed. In cases where the storage devices 350 are installed in different systems, instructions 312 may monitor a temperature of each of those different systems. The temperature may be a global temperature of the system, a regional temperature with the system, a plurality of temperatures from the system, a temperature of a component of the system (e.g., other than a storage device, such as a processor temperature), etc.

Instructions 314 cause the processing resource 302 to restructure the received I/O requests 360 directed to the storage device 350-1 by distribution of at least some of the received I/O requests 360 among the other storage devices (e.g., 350-2 through 350-N), as distributed I/O requests 370. The distributed I/O requests 370 may be submitted to various ones of the storage devices 350, while others of the storage devices 350 may not receive any of the I/O requests. In some implementations, instructions 314 may be utilized by instruction 112 of apparatus 100 to restructure I/O requests, to conform a monitored power variable of the storage device 350-1 to a power policy. The power policy may specify a power variable goal or target for each storage device 350 individually, for groups of the storage devices 350, or for ail of the storage devices 350 collectively.

In some implementations, instructions 314 may search for a storage device 350 for which the corresponding power variable (as monitored by instructions 312) is in conformance with the power policy. Moreover, in some implementations, instructions 314 may rank the storage devices 350 by the amount of margin between the corresponding power variable and power policy for each device (e.g., the delta between a temperature limit for a storage device and a present monitored temperature of that storage device), and select storage device(s) 350 with a high margin. Such storage devices that are in conformance with the power policy or have margin are candidates for receiving distributed I/O requests 370. If the I/O request to be distributed is a data read request, the candidates may be further narrowed to which of the candidates include a copy of the data requested by the I/O request (e.g., if the data is mirrored, etc.).

Instructions 314 then distributes at least some of the received I/O requests 360 as distributed I/O requests 370 to the candidate storage devices. To determine how much I/O workload should be distributed to individual ones of the candidate storage devices, instructions 314 may model the predicted impact of the I/O requests to be distributed on those candidate storage devices and verify that the power variable of those candidate storage devices will remain in compliance with the power policy. Instructions 314 may then adjust the distribution of I/O requests (e.g., shift some I/O requests from storage device to another storage device with greater margin) based on the modeling and verification.

By distributing the received I/O requests 360 as distributed I/O requests 370 among the other storage devices, I/O activity may be offloaded from the storage device 350-1, thus allowing the power variable of the storage device 350-1 to reduce and to conform with the power policy. In some cases, some of the storage devices 350 may be idle and/or cooler than the storage device 350-1, and thus distributed I/O requests would need to overcome thermal inertial of cool storage devices (as well as any cool ambient air) before causing a power variable (e.g., a thermal power variable) to increase appreciably.

Thus, distributing I/O requests among multiple storage devices (including cold devices) may have less of an overall thermal power impact than submitting those same I/O requests to one storage device or a smaller group of storage devices. Accordingly, distribution of at least some of the received I/O requests 360 directed to the storage device 350-1 among the other storage devices 350 may maintain the temperature of system(s) (e.g., system(s) in which the storage devices 350 are installed) below a predefined temperature threshold. In some implementations, instructions 314 may also control the distribution of I/O requests via closed-loop control of the temperature of the system(s), to ensure that overall system temperature(s) do not exceed predefined temperature threshold(s) or are not otherwise negatively impacted by the distribution of I/O requests.

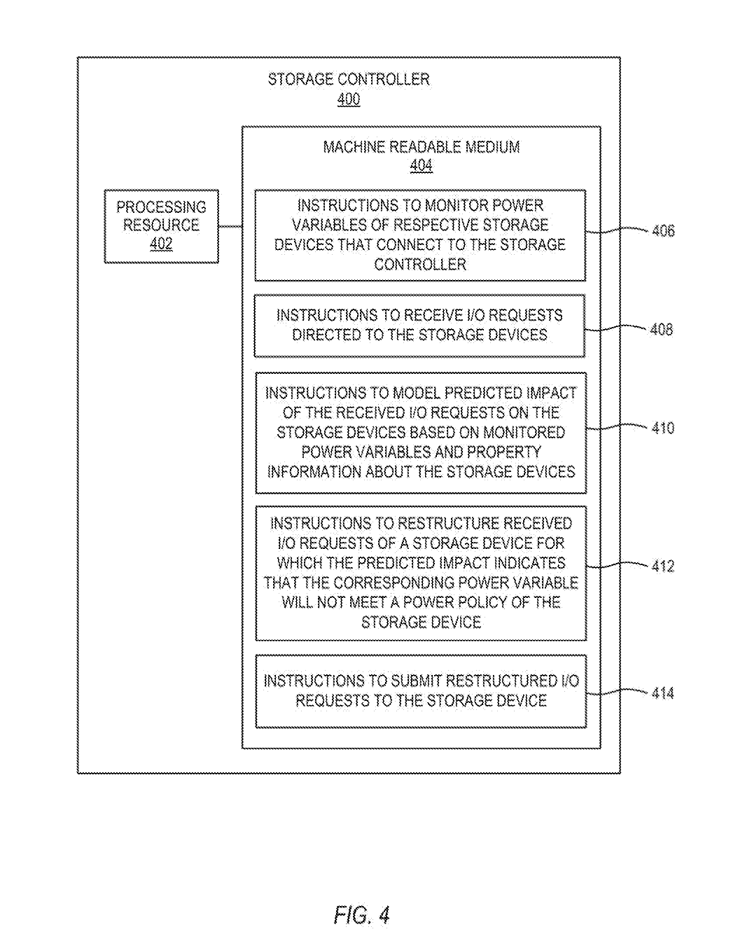

FIG. 4 is a block diagram of an example storage controller 400 that includes a machine readable medium encoded with instructions to restructure I/O requests directed to a storage device. The storage controller 400 includes a processing resource 402 and a non-transitory machine readable medium 404, which may be analogous in many respects to the processing resource 102 and the non-transitory machine readable medium 104, respectively. The machine readable medium 404 may store instructions 406, 408, 410, 412, 414.

The machine readable medium 404 may be disposed within the storage controller 400, as shown in FIG. 4, in which case the executable instructions may be deemed installed or embedded. Alternatively, the machine readable medium 404 may be a portable (e.g., external) storage medium, and may be part of an installation package.

The storage controller 400 may communicate with a plurality of storage devices, each of which may be analogous to the storage device 150. For example, the storage controller 400 may communicate with the storage devices via a data bus and/or via a wired or wireless network.

Instructions 406, when executed by the processing resource 402, may monitor power variables of respective storage devices that connect to the storage controller. The power variables that are measured for respective storage devices may be the same or different. The power variables may be analogous to those described above with respect to instructions 110, and may be an implicit or explicit representation of thermal activity at respective storage devices. For example, the power variable may be a measurement of thermal power generated, a measurement of electrical power consumed, an estimate of thermal power generated, or an estimate of electrical power consumed, among other values.

Instructions 408, when executed by the processing resource 402, may receive I/O requests directed to the storage devices. The I/O requests may be analogous in many respects to the I/O requests 160 described above.

Instructions 410, when executed by the processing resource 402, may model a predicted impact of the received I/O requests on the storage devices based on the monitored power variables and property information about the storage devices. For example, instructions 410 may model the predicted impact for each of the storage devices in a manner analogous to that described above with respect to instructions 112.

Instructions 412, when executed by the processing resource 402, may restructure the received I/O requests of a storage device for which the predicted impact indicates that the corresponding power variable of the storage device will not meet a power policy of the storage device. The power policy may be analogous in many respects to the power policy described above with respect to instructions 112. For example, instructions 412 may compare the predicted impact modeled by instructions 410 (e.g., on a temperature power variable, to illustrate) of servicing I/O requests on particular storage device, to a power policy for that storage device (e.g., a temperature threshold), and if the predicted impact will not meet the power policy (e.g., the power variable exceed the temperature threshold), then instructions 412 cause the processor to restructure the received I/O requests for that storage device.

Instructions 414, when executed by the processing resource 402, may submit restructured I/O requests to the storage device. The storage device then services the restructured I/O requests.

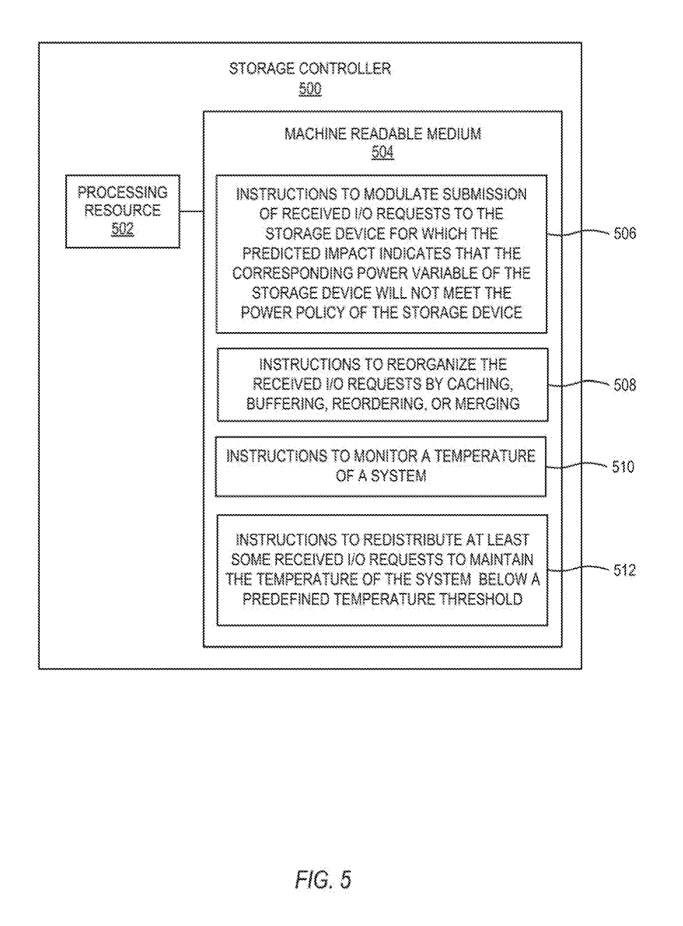

FIG. 5 is a block diagram of an example storage controller 500 that includes a machine readable medium encoded with instructions to modulate, reorganize, or redistribute I/O requests. The storage controller 500 includes a processing resource 502 and a non-transitory machine readable medium 504, which may be analogous in many respects to the processing resource 102 and the non-transitory machine readable medium 104, respectively. The machine readable medium 504 may store instructions 506, 508, 510, 512.

The machine readable medium 504 may be disposed within the storage controller 500, as shown in FIG. 5, in which case the executable instructions may be deemed installed or embedded. Alternatively, the machine readable medium 504 may be a portable (e.g., external) storage medium, and may be part of an installation package.

The storage controller 500 may communicate with a plurality of storage devices, each of which may be analogous to the storage device 150. For example, the storage controller 500 may communicate with the storage devices via a data bus or via a wired or wireless network.

At least some of the instructions encoded on the machine readable medium 504 may be utilized by instruction 412 to restructure I/O requests. In other words, instructions 412 may utilize instructions 506, 508, 510, 512, and combinations thereof, to conform a monitored power variable of a storage device to a power policy.

Instructions 506, when executed by the processing resource 502, may modulate submission of received I/O requests to a storage device for which the predicted impact indicates that the corresponding power variable of the storage device will not meet the power policy of the storage device (i.e., as determined by instructions 412), according to modulation parameters that include an I/O request submission rate, an I/O request submission duty cycle, or a number of available I/O lanes. Instructions 508, when executed by the processing resource 502, may reorganize the received I/O requests by caching, buffering, reordering, or merging at least a portion of the received I/O requests.

Instructions 510, when executed by the processing resource 502, may monitor a power value of a system in which at least some of the storage devices are installed (e.g., a global system temperature, a regional temperature, etc.). Instructions 512, when executed by the processing resource 502, may redistribute at least some of the received I/O requests directed to the storage devices to maintain the temperature of the system (monitored by instructions 510) below a predefined temperature threshold. Moreover, instructions 512 may redistribute the I/O requests to allow the storage devices to each conform with a power policy.

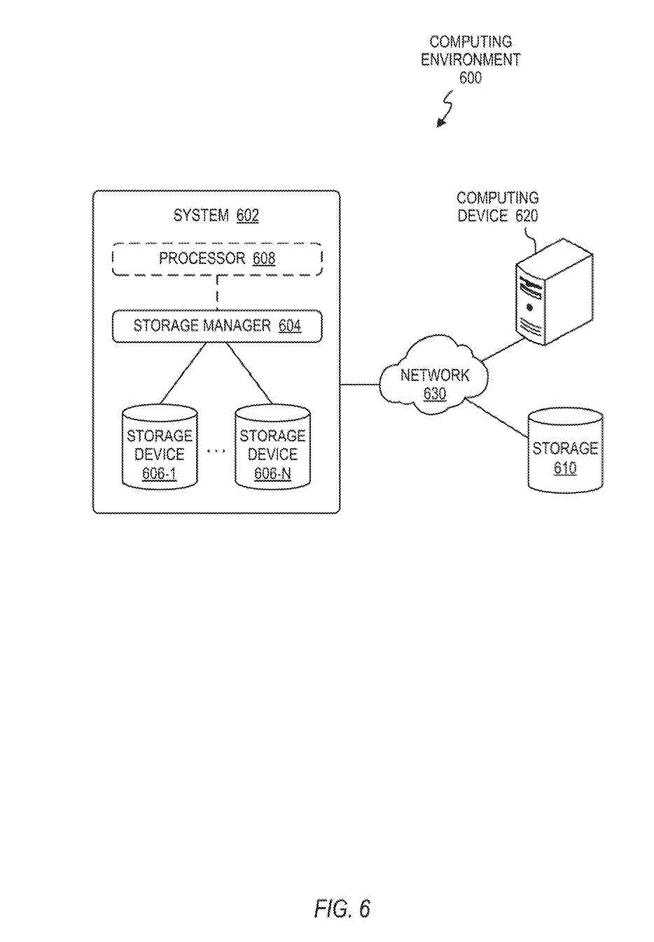

FIG. 6 is a block diagram of an example computing environment 600 that may employ a storage manager 604 according to an implementation. The storage manager 604 may include the apparatus 100, 200, or 300 or the storage controller 400 or 500, or any combination of the foregoing. The storage manager 604 is installed in a system 602, which may be a computing system, a storage system, or the like. The storage manager 604 may be coupled to at least one storage device 606, and in some implementations, a plurality of storage devices 606-1 through 606-N. In some implementations, the storage manager 604 may communicate with a storage 610 via a network 630. The storage 610 may be, for example, a network attached storage, a storage array, a data center, etc.

In some implementations, the system 602 may include a processor 608 coupled to the storage manager 604, such as in the case of a computing system (e.g., a server, a desktop computer, etc.). In such a case, the I/O requests directed to the storage devices may originate from the processor 608. In other implementations, such as in a storage system, the I/O requests may originate externally to the system 602. For example, the storage manager 604 of the system 602 may receive I/O requests from a computing device 620 via a network 630.

Accordingly, the storage manager 604 may be understood to be a central point through which I/O requests flow to the storage devices 606. The storage manager 604 may be implemented as a controller or as a driver (e.g., a set of machine readable instructions to enable the system 602 to interface with the storage devices 606).

In operation, the storage manager 604 may monitor power variables (e.g., temperature) tor at least the storage devices 606 included within the system 602. In some implementations, the storage manager 604 also may monitor power variables for storage 610, and other storage external to the system 602. The storage manager 604 receives I/O requests directed to the storage devices 606. If the power variable of a particular storage device (e.g., 606-1) approaches or exhibits non-compliance with a power policy, the storage manager 604 can restructure I/O requests directed to that particular storage device (e.g., 606-1) by reorganization (e.g., caching, buffering, reordering, merging), modulation, or distribution among other storage devices. Restructuring I/O requests may involve other storage devices included in the system 602 and/or may involve external storage, such as storage 610. For example, the storage manager 604 may employ any of the instructions described above with respect to FIGS. 1-5.

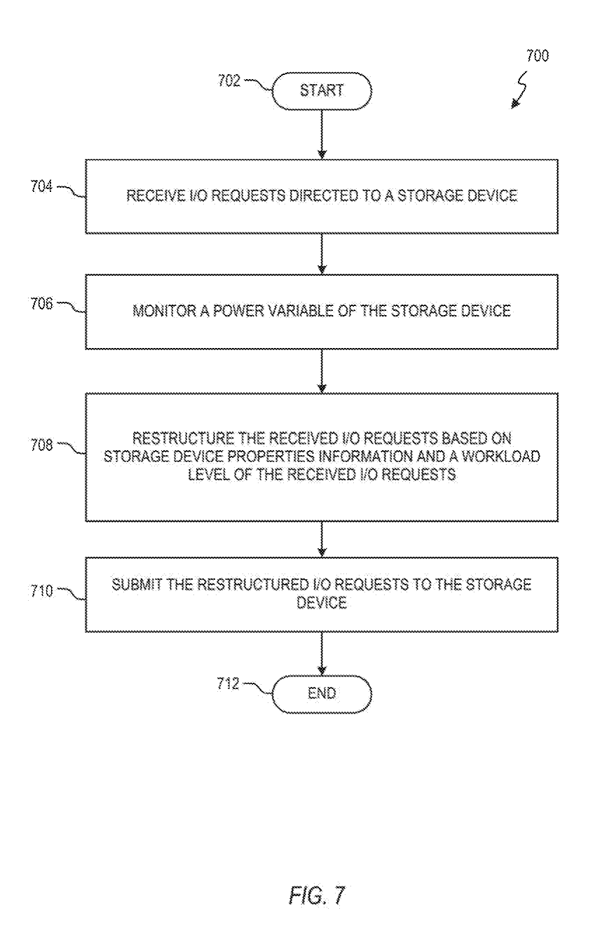

FIG. 7 is a flowchart of an example method 700 for restructuring I/O requests directed to a storage device. Method 700 may be implemented in the form of executable instructions stored on a machine readable medium and executed by a processing resource (e.g., a microcontroller, a microprocessor, central processing unit core(s), an ASIC, a FPGA, etc.) and/or in the form of electronic circuitry. For example, method 700 below may be described as performed by a storage controller, such as the storage controller 400 of FIG. 4. Various other devices may be used as well, such as, for example, the apparatus 100. In some implementations of the present disclosure, one or more blocks of method 700 may be executed substantially concurrently or in a different order than shown in FIG. 7. In some implementations of the present disclosure, method 700 may include more or less blocks than are shown in FIG. 7.

The method 700 may begin at block 702, and continue to block 704, where a storage controller receives I/O requests directed to a storage device. At block 706, the storage controller monitors a power variable of the storage device. At block 708, the storage controller restructures the received I/O requests based on storage device properties information and a workload level of the received I/O requests. At block 710, the storage controller submits the restructured I/O requests (restructured by block 708) to the storage device. When the storage device services the restructured I/O requests, the power variable may conform to a power policy more closely than if the storage device had serviced the received I/O requests without restructuring. At block 712, the method 700 ends.

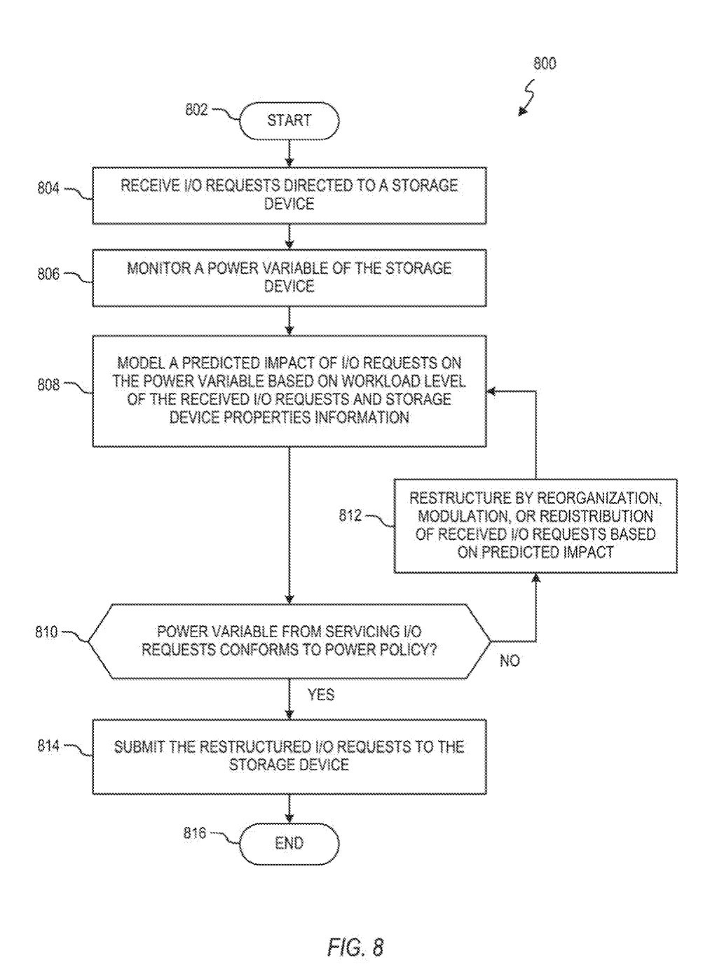

FIG. 8 is a flowchart of an example method 800 for modeling a predicted impact of received I/O requests and restructuring the I/O requests based on the predicted impact. As with method 700, method 800 may be implemented in the form of executable instructions stored on a machine readable medium and executed by a processing resource and/or in the form of electronic circuitry. Method 800 may be described as being performed, at least in part, by a storage controller like the storage controller 400 or 500 or a combination thereof. Various other devices may be used as well, such as, for example, the apparatuses 100, 200, 300, or combinations thereof. In some implementations of the present disclosure, one or more blocks of method 800 may be executed substantially concurrently or in a different order than shown in FIG. 8. In some implementations of the present disclosure, method 800 may include more or less blocks than are shown in FIG. 8.

The method 800 may begin at block 802, and continue to block 804, where a storage controller receives I/O requests directed to a storage device. At block 806, the storage controller monitors a power variable of the storage device. At block 808, the storage controller models a predicted impact of the received I/O requests on the power variable (monitored at block 806) based on the workload level and storage device properties information.

If, at block 810, the power variable for servicing the I/O requests as predicted by modeling at block 808 does not conform to a power policy (“NO” at block 810), the method 800 proceeds to block 812. At block 812, the storage controller restructures the I/O requests based on the power variable, storage device properties information, and a workload level of the received I/O requests. The restructuring may include reorganizing, modulating, or redistributing at least a portion of the received I/O requests based on the predicted impact. More particularly, reorganizing may include caching, buffering, reordering, or merging at least some of the received I/O requests.

After block 812, the method 800 proceeds again to blocks 808 and 810, until the I/O requests have been satisfactorily restructured (i.e., if modeled power variable conforms with the power policy). In some implementations, the storage controller may programmatically formulate different restructuring strategies (e.g., at block 812), model the predicted impact on the power variable for those strategies (e.g., by repeating block 808), and select a strategy with a predicted impact that conforms most closely with the power policy (e.g., by testing the predicted impact at block 810).

If, at block 810, the power variable for servicing the I/O requests as predicted by modeling at block 808 conforms to a power policy (“YES” at block 810), the method 800 proceeds to block 814, where the storage controller submits the I/O requests, whether restructured or not restructured, to the storage device for servicing. After block 814, the method 800 ends at block 816.

In view of the foregoing description, it can be appreciated that a power variable related to thermal activity of a storage device (e.g., temperature of the storage device) can be controlled in a flexible and robust manner, and detrimental effects of excessive thermal activity on a computing system or storage system may be mitigated. The systems and techniques described herein may be complementary to heat exchange systems (e.g., fans), either operating concurrently or in reserve. Moreover, by virtue of restructuring the I/O requests from a central point (e.g., storage manager) upstream of the storage devices, the systems and techniques of the present disclosure may be device-agnostic and can work with different types of storage devices (e.g., SSD, HDD, NVM, optical drives, etc.), storage devices

What is claimed:

1. An apparatus comprising:
a processing resource; and
a non-transitory machine readable medium storing instructions that, when executed by the processing resource, cause the processing resource to:
receive input/output (I/O) requests directed to a storage device,
monitor a power variable of the storage device,
retrieve storage device properties information,
restructure the received I/O requests, based on the retrieved storage device properties information and a workload level of the received I/O requests, the restructured I/O requests when serviced by the storage device allow the power variable to conform with a power policy, and
submit the restructured I/O requests to the storage device.

2. The apparatus of claim 1, wherein the processing resource restructures the received I/O requests by caching, buffering, reordering, or merging at least some of the received I/O requests.

3. The apparatus of claim 1, wherein the instructions, when executed by the processing resource, cause the processing resource to monitor the power variables of other storage devices for which the processing resource receives I/O requests, and
wherein the processing resource restructures the received I/O requests directed to the storage device by distribution of at least some of the received I/O requests among the other storage devices.

4. The apparatus of claim 1, wherein the processing resource restructures the received I/O requests by modulated submission of the received I/O requests to the storage device according to modulation parameters that include an I/O request submission rate, an I/O request submission duty cycle, or a number of available I/O lanes.

5. The apparatus of claim 1, wherein the storage device properties information includes a media type of the storage device, an electrical power consumption rate for the workload level, or a thermal power generation rate for the workload level.

6. The apparatus of claim 1, wherein the power variable is a speed of a fan, a measurement of thermal power generated at the storage device, a measurement of electrical power consumed by the storage device, an estimate of thermal power generated by the storage device calculated by the processing resource based on monitored workload levels and storage device properties information, or an estimate of electrical power consumed by the storage device calculated by the processing resource based on monitored workload levels and storage device properties information.

7. The apparatus of claim 3, wherein the instructions, when executed by the processing resource, cause the processing resource to monitor a temperature of a system in which the storage device and the other storage devices are installed,
wherein the distribution of at least some of the received I/O requests directed to the storage device among the other storage devices maintains the temperature of the system below a predefined temperature threshold.

8. A non-transitory machine readable medium storing instructions executable by a processing resource of a storage controller, the non-transitory machine readable medium comprising:
instructions to monitor power variables of respective storage devices that connect to the storage controller;
instructions to receive input/output (I/O) requests directed to the storage devices;
instructions to model a predicted impact of the received I/O requests on the storage devices based on the monitored power variables and property information about the storage devices;
instructions to restructure the received I/O requests of a storage device for which the predicted impact indicates that the corresponding power variable of the storage device will not meet a power policy of the storage device; and
instructions to submit restructured I/O requests to the storage device.

9. The non-transitory machine readable medium of claim 8, wherein the instructions to restructure include:
instructions to modulate submission of the received I/O requests to the storage device for which the predicted impact indicates that the corresponding power variable of the storage device will not meet the power policy of the storage device, according to modulation parameters that include an I/O request submission rate, an I/O request submission duty cycle, or a number of available I/O lanes, and
instructions to reorganize the received I/O requests by caching, buffering, reordering, or merging at least a portion of the received I/O requests.

10. The non-transitory machine readable medium of claim 8, further comprising:
instructions to monitor a power value of a system in which the storage devices are installed; and
instructions to redistribute at least some of the received I/O requests directed to the storage devices to maintain the temperature of the system below a predefined temperature threshold.

11. The non-transitory machine readable medium of claim 8, wherein the power variable is a measurement of thermal power generated, a measurement of electrical power consumed, an estimate of thermal power generated, or an estimate of electrical power consumed.

12. The non-transitory machine readable medium of claim 8, wherein the property information includes, for each storage device, a media type, an electrical power consumption rate for the workload level, or a thermal power generation rate for the workload level.

13. A method comprising:
receiving, at a storage controller, input/output (I/O) requests directed to a storage device;
monitoring, by the storage controller, a power variable of the storage device;
restructuring, by the storage controller, the received I/O requests based on storage device properties information and a workload level of the received I/O requests; and
submitting the restructured I/O requests to the storage device,
wherein servicing of the restructured I/O requests by the storage device results in the power variable conforming to a power policy more closely than servicing the received I/O requests without restructuring.

14. The method of claim 13, wherein the restructuring includes:
modeling a predicted impact of the received I/O requests on the power variable based on the workload level and the storage device properties information, and
reorganizing, modulating, or redistributing at least a portion of the received I/O requests based on the predicted impact.

15. The method of claim 14, wherein reorganizing includes caching, buffering, reordering, or merging at least some of the received I/O requests.
